(19) United States
(12) Patent Application Publication
(10) Pub. No.: US 2006/0037136 A1
(43) Pub. Date: Feb. 23, 2006

(54) Identification system for a patient transfer mattress

(76) Inventors: Robert E. Weedling, Center Valley, PA (US); James E. Weedling, Center Valley, PA (US)

Correspondence Address: John J. Marshall;Drinker Biddle & Reath LLP, One Logan Square, 18th and Cherry Streets, Philadelphia, PA, 19103-6996, US

(21) Appl. No.: 11/209,063

(22) Filed: Aug. 22, 2005

Related U.S. Application Data
(60) Provisional application No. 60/603,737, filed on Aug. 23, 2004.

(51) Int. Cl. A47C 27/08; A61G 7/14

(52) U.S. Cl. 5/81.1 HS; 5/706

(57) ABSTRACT

A system for visually identifying a patient transfer device, and distinguishing the patient transfer device from other patient transfer devices in a set of transfer devices is provided. The transfer device includes an inflatable mattress. The system comprises a plurality of identifier elements arranged about the mattress and adapted to present a unified appearance. The appearance of the identifier elements substantially distinct from that of the mattress such that the eye of a viewer is automatically drawn to the identifier elements. The identifier elements may include a plurality of side pull straps adapted for sliding the mattress along an underlying surface. According to one embodiment, the identifier elements include tabs to which fasteners are mounted for releasably attaching an accessory to the mattress.

### CROSS-REFERENCE TO RELATED APPLICATION

This application claims priority of U.S. Provisional Application No. 60/603,737, filed Aug. 23, 2004.

### FIELD OF THE INVENTION

The present invention relates generally to patient transfer mattresses, and, more particularly, to an identification system for a transfer mattress.

### BACKGROUND OF THE INVENTION

Certain patient transfer mattresses include an inflatable plenum and a bottom sheet having a plurality of holes for creating a cushion of air beneath the mattress. The cushion of air facilitates sliding movement of the mattress along an underlying support surface. An example of such a transfer mattress is disclosed in U.S. Pat. No. 5,561,873 (Weedling).

It is known, as disclosed in U.S. patent application Ser. No. 10/143,139, published as Pub. No. 2002/0166168A, to provide a patient transfer mattress having an accessory removably attached to the mattress and located on the top surface of the mattress. The various accessories of the '139 application are attached to the mattress by fasteners mounted on tabs. The tabs for the fasteners are located on the top of the mattress adjacent the periphery of the mattress.

The patient transfer mattress of the '139 application includes straps on opposite sides of the mattress for securing a patient to the mattress. The mattress also includes looped handles on opposite sides of the mattress to facilitate sliding movement of the mattress along a support surface.

What is needed is an identification system for a patient transfer mattress that visually distinguishes the mattress from other mattresses and provides for rapid identification of the mattress based on only a cursory examination of the mattress.

### SUMMARY OF THE INVENTION

According to one aspect of the present invention, a system for visually identifying a patient transfer device, and distinguishing the patient transfer device from other patient transfer devices in a set of transfer devices is provided. The transfer device includes an inflatable mattress. The system comprises a plurality of identifier elements arranged about the mattress and adapted to present a unified appearance. The appearance of the identifier elements substantially distinct from that of the mattress such that the eye of a viewer is automatically drawn to the identifier elements.

According to another aspect of the invention, a patient transfer device comprises an inflatable mattress defining a plurality of holes in a bottom sheet of the mattress for creating a cushion of escaping air beneath the transfer mattress to facilitate sliding movement of the mattress along an underlying surface. The patient transfer device also comprises a plurality of side pull straps each adapted for application of a pulling force to the mattress. The patient transfer device further comprises an accessory attached to the mattress. The side pull straps and tabs are made from materials having a color that is substantially identical such that the side pull straps and tabs function to visually identify the mattress and distinguish the mattress from other mattresses for matching the mattress with a corresponding accessory.

### BRIEF DESCRIPTION OF THE DRAWINGS

FIG. 1 is a top perspective view of a patient transfer mattress having an identification system according to a first exemplary embodiment of the invention.

FIG. 2 is a bottom perspective view of the patient transfer mattress of FIG. 1.

FIG. 3 is a perspective view of a patient transfer mattress and sanitary liner having an identification system according to a second exemplary embodiment of the invention.

FIG. 4 is a perspective view of a patient transfer mattress having an identification system according to a third exemplary embodiment of the invention.

FIG. 5 is a perspective view of a patient transfer mattress having an identification system according to a fourth exemplary embodiment of the invention.

### DESCRIPTION OF THE INVENTION

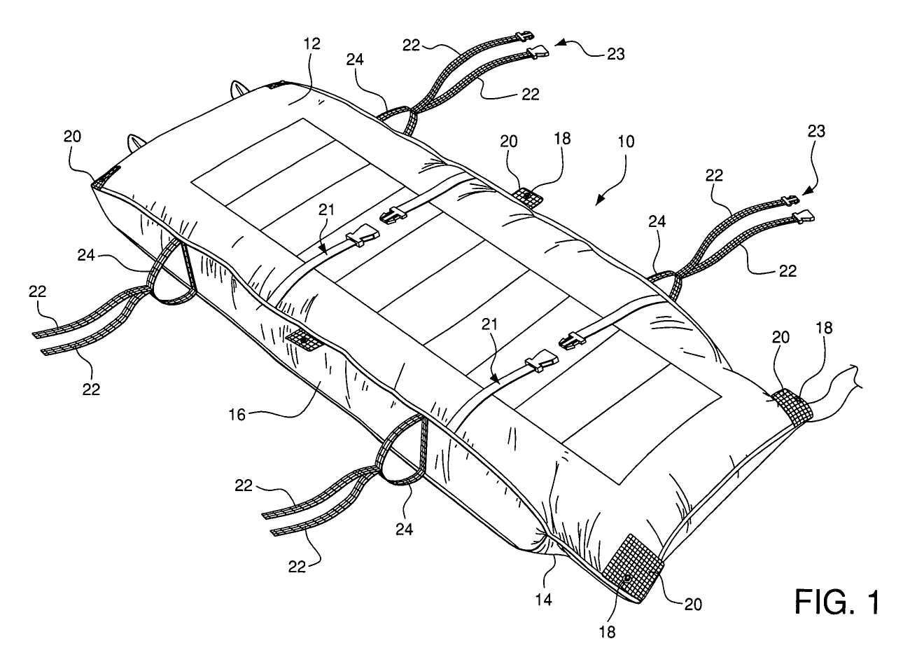

Referring to the drawings where like numerals identify like elements, there is shown in FIG. 1 a patient transfer mattress 10 having an identification system according to an exemplary embodiment of the invention. As described below in greater detail, the identification system of the present invention provides visual identification of a mattress (e.g., for distinguishing the mattress from other mattress in a set of mattresses, to match a particular mattress with an associated accessory such as a sanitary liner, etc.).

The transfer mattress 10 is inflatable and includes a top sheet 12, a bottom sheet 14 and side panels 16. The bottom sheet 14 includes a plurality of tiny openings for discharging air from the mattress 10 to create a cushion of air beneath the mattress 10. The cushion of air beneath the mattress 10 facilitates sliding movement of the mattress 10 along an underlying support surface. Preferably, a plenum defined by the top and bottom sheets 12, 14 includes longitudinally extending side air chambers and transverse chambers extending between the side chambers. An example of suitable construction for the longitudinal and transverse chambers of mattress 10 are described in U.S. Pat. No. 5,067,189 (Weedling), reissued as RE 35,299, and U.S. Pat. No. 5,561,873, both of which are incorporated herein by reference in their entireties.

The transfer mattress 10 also includes a plurality of fasteners 18 each mounted on a tab 20. The tabs 20 are secured to the mattress 10 adjacent a periphery of the mattress 10. The fasteners 18 provide for releasable attachment of an accessory to the transfer mattress 10. Examples of suitable accessories for attachment to the transfer mattress 10 using the fasteners 18 are provided in U.S. Publication No. 2002/0166168A, which is incorporated herein by reference in its entirety. It should be understood that the invention is not limited to the depicted arrangement of fasteners and that the fasteners 18 could be located anywhere on the mattress.

The transfer mattress 10 includes patient restraint straps 21 for securing a patient to the mattress 10. The transfer mattress 10 also includes elongated pull straps 22 on opposite sides of the mattress 10. In the depicted mattress 10, each of the pull straps 22 is secured to a loop 24, which is, in turn, secured to one of the side panels 16 of the mattress 10. Constructed in this manner, the mattress 10 provides alternative means of applying pulling force to the sides of the mattresses (e.g., for sliding the transfer mattress 10 along an underlying support surface). For example, a caregiver could grasp the loops 24 located on one side of the mattress from a location adjacent the mattress 10 to apply a pulling force to the mattress 10. Alternatively, the caregiver could grasp the elongated pull straps 22 from a location at a distance from the mattress 10 to apply a pulling force to the mattress 10. This situation could present itself, for example, when it is desired to transfer a patient from a first support surface (e.g., an examination table) to a second support surface (e.g., a gurney) located between the caregiver and the first support surface. The elongated pull straps 22 allow a caregiver in to apply a pulling force to the mattress 10 in such situations with the back of the caregiver is in a substantially upright condition. This serves to prevent injury of the caregiver that might otherwise occur (e.g., if the caregiver were to reach across the intermediate support surface and apply a pulling force while the back of the caregiver was in a hunched-over condition).

The depicted transfer mattress 10 includes pairs of elongated straps 22 at each of four locations about the periphery of the mattress 10. As shown in FIG. 1, the straps 22 might include attachment means 23 (e.g., buckles, hook and loop material, snaps, etc.) adjacent terminal ends of the straps 22. The attachment means 23 provide for attachment of one of the straps 22 of a pair of straps 22 at a given location to the other one of the straps 22 at that location. Attached to each other in this manner, the pair of straps 22 could then be grasped like a loop adjacent the terminal ends of the straps 22. It is conceivable, if pairs of straps 22 located on opposite sides of the mattress each included attachment means 23, that a strap 22 from one side of the mattress could be attached to a strap 22 from the other side of the mattress (e.g., to provide patient restraint in addition to, or in lieu of, the restraints 21).

As shown, each of the elongated pull straps 22 is attached to the looped strap 24 substantially midway between the ends of the looped strap 24. This arrangement serves to distribute a force applied to the pull strap 22 (e.g., an applied pulling force to slide the mattress 10) substantially evenly between the opposite ends of the looped straps 24 and, therefore, substantially evenly between the top and bottom of the mattress 10. According to one preferred embodiment, the pull straps 22 and the looped straps 24 are made from a webbing material such as a nylon weave.

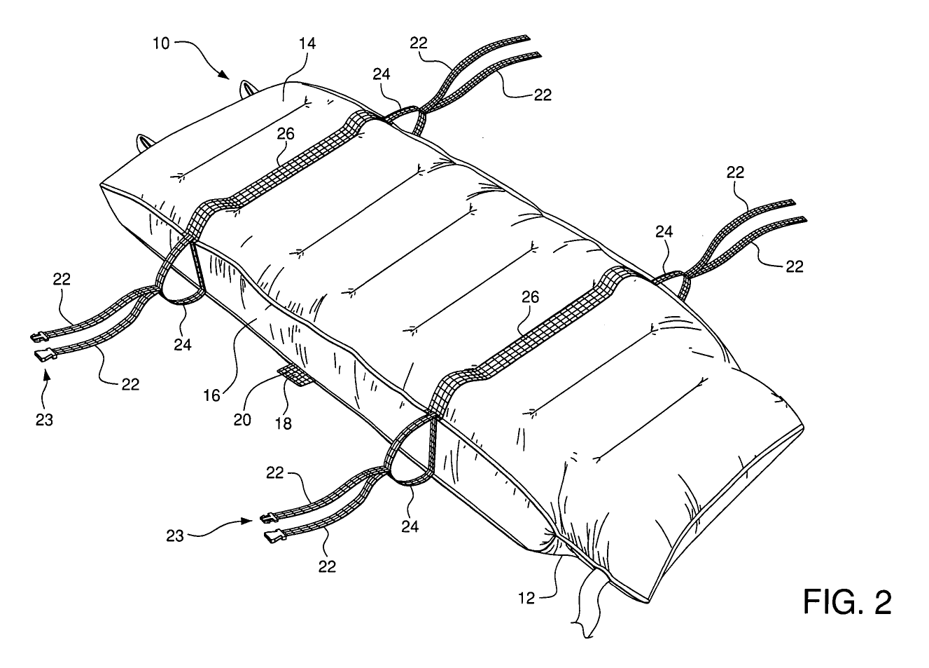

Referring to FIG. 2, the transfer mattress 10 also includes elongated cross members 26 on bottom sheet 14 extending between the opposite side panels 16 adjacent the attachment locations for the looped straps 24. The cross members 26 are preferably secured to the transfer mattress 10 (e.g., by sewing the cross members 26 to the bottom sheet 14). The cross members 26 act as stabilization bands to provide additional reinforcement between opposite sets of the straps 22, 24 and further facilitates a caregiver making a slight angular adjustment of the transfer mattress 10 as pulling force is applied. Such angular adjustments would be desired for example to facilitate a stable transfer of a patient, particularly an obese patient, who is located on the mattress 10 in an off-centered condition.

As described above, the present invention provides an identification system for visually distinguishing the mattress from other mattresses. In the depicted mattress 10, the materials that are used to form each of the fastener tabs 20, the elongated pull straps 22, the looped straps 24 and the cross members 26, have the same color (e.g., yellow). The matching color for identifying the mattress 10 is illustrated in FIGS. 1 and 2 by the matching lining pattern applied to each of the above-listed elements of mattress 10. As shown in FIG. 2, the color-coded identifier elements of the depicted mattress 10 are desirably distributed about the mattress 10. As a result, at least one of these elements will be presented to a viewer of the mattress 10 regardless of where the mattress 10 is viewed from. Thus, the identification system of the present invention allows a viewer to distinguish the mattress 10 from other mattresses based on only a cursory visual examination of the mattress 10.

Preferably, the materials that form the remainder of the mattress are colored in shades that are distinct from that selected for the color-coded elements of the identification system. For example, if yellow is chosen as the color for the color-coded identifier elements of the mattress 10, the remainder of the mattress would preferably be made from materials having colors that are distinct from yellow (e.g., blue, gray, black, etc.). As a result, the eyes of a viewer will automatically be drawn towards the color identifier elements of the mattress 10. Therefore, in addition to providing for visual identification of the mattress (e.g., to distinguish the mattress from other mattresses of a set of mattress), the color coding system of the invention also provides a targeting feature by which the identifier elements can be rapidly located. With respect to the fastener tabs 20, for example, the targeting feature provided by the identification system desirably facilitates rapid location of the tabs for attaching an accessory to the mattress 10 using the fasteners 18 mounted on the tabs.

According to one exemplary embodiment of the invention, the mattress 10 is included in a set of mattresses and is distinguished from the other mattresses of the set based on the color-coded identifier elements described above. Each mattress of the set might differ from the other mattresses of the set based on the overall size of the mattress, for example. The present invention, however, is not limited in use to distinguishing mattresses based on size and could be used to distinguish mattresses for other reasons (e.g., based on variations in the internal chamber configuration of the mattress; based on differences in the construction or arrangement of the pull straps or the accessory fasteners; etc.). A set of mattresses differentiated based on size, therefore, might includes mattresses having color-coded identifiers respectively colored yellow, blue, silver, gold, etc.

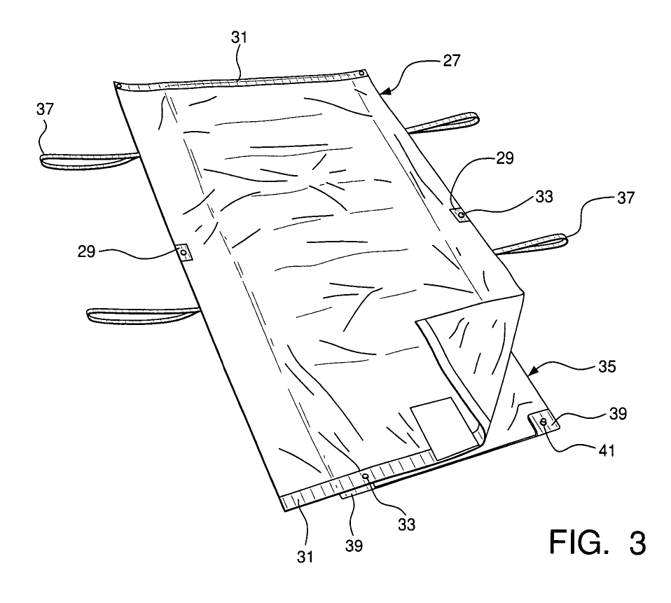

Referring to FIG. 3, there is shown a sanitary liner 27 that, according to one exemplary embodiment of the invention, is part of a set of sanitary liners of varying size having color-coded identifiers used to match a respective one of the liners of the set with a corresponding mattress of a set of mattresses, such as the set of mattresses described in the preceding paragraph. As shown, the sanitary liner 27 includes selected elements that are made from materials that are colored in the same color shade (e.g., blue). Thus, a liner 27 having color-coded identifiers that are blue would be adapted to be readily matched with a corresponding mattress of a set of mattresses also having color-coded identifiers that are blue. As shown, the color-coded identifier elements of the liner 27 include side tabs 29 and edge strips 31 on which fasteners 33 are mounted for attachment of the liner 27 to the corresponding mattress.

The sanitary liner 27 is shown in FIG. 3 with a patient transfer mattress 35 having looped handles 37 on opposite sides of the mattress and tabs 39 on which fasteners 41 are mounted, for attaching the liner 27 to the mattress 35 for example. The transfer mattress 35 is shown in a deflated condition. As illustrated by the matching line patterns included on the mattress 35 and liner 27, the looped handles 37 of the transfer mattress 35 are color-coded such that the color of the looped handles 37 matches the color of the color-coded identifier elements of the liner 27. This arrangement allows a viewer to rapidly distinguish the liner 27 from other liners, and to match the liner 27 with the corresponding mattress 35, based on only a cursory visual examination of the liner and mattress. In addition to the side tabs 29 and edge strips 31, the sanitary liner 27 could also include looped handles (not shown) on opposite sides of the sanitary liner, similar to the looped handles 35 of transfer mattress, that are also made from a material having the color selected for the color-coded identifier elements.

In a similar manner as described above for the mattress 10, the rest of the liner is preferably made from materials colored in a shade that is distinguishable from the blue shade of the identifier elements such that the eye of the viewer is automatically drawn to the identifier elements. This targeting feature serves to facilitate location of the fasteners 33 on liner 27 and the fasteners 41 of the mattress 35 for attaching the liner 27 to the corresponding mattress 35.

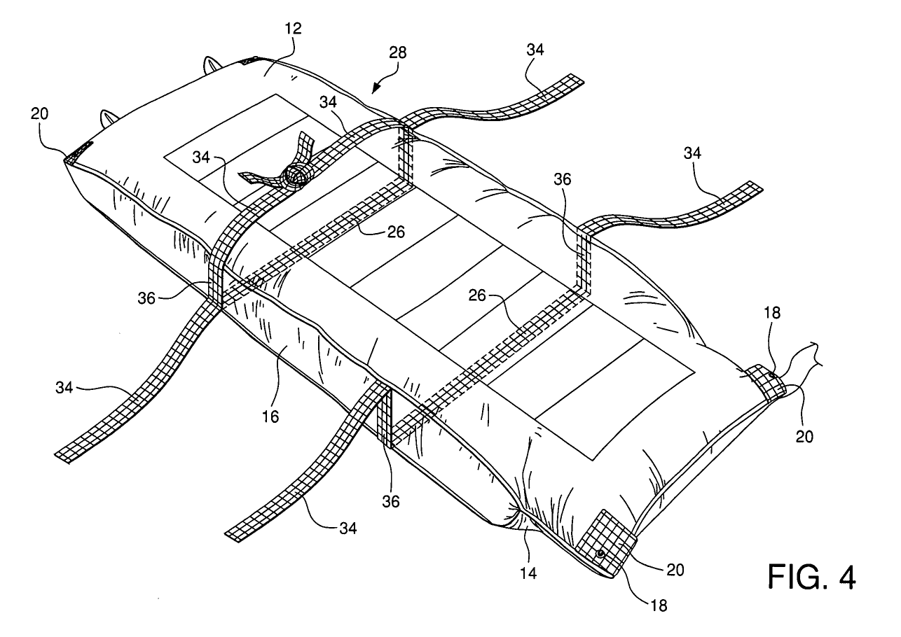

Referring to FIG. 4, there is shown a transfer mattress 28 according to a second exemplary embodiment of the invention. Similar to transfer mattress 10, transfer mattress 28 includes top and bottom sheets 12, 14 and opposite side panels 16. Similar to transfer mattress 10, transfer mattress 28 also includes fasteners 18 mounted on tabs 20 for releasable attachment of an accessory (e.g., a sanitary liner) to the mattress 28. Transfer mattress 28 also includes elongated pull straps 34 that could be used to apply a pulling force to slide the mattress 28 along an underlying support surface, as described above for the pull straps 22 of mattress 10. Alternatively, the elongated pull straps 34 could be used to secure a patient to the mattress 28 (e.g., by tying the ends of opposite ones of the pull straps as shown). The elongated pull straps 34 could also include attachment means, as described above for mattress 10, for attaching opposite ones of the pull straps 34 together instead of tying the ends as shown.

In contrast to the transfer mattress 10, transfer mattress 28 does not include looped straps located between the elongated pull straps 34 and the side panels 16. Instead, each of the elongated straps 34 is attached to a vertical member 36 extending along one of the side panels 16 between the top and bottom sheets 12, 14. Preferably, the vertical members 36 are secured to the side panels by sewing the vertical members 36. The transfer mattress 28 also includes cross members 26 that, similar to cross members 26 of transfer mattress 10, extend across the bottom sheet 14 between the pull straps 34.

The pull straps 34 of transfer mattress 28 may be attached to the vertical members 36 at any location along the vertical member 36 (e.g., adjacent the top sheet 12, adjacent the bottom sheet 14, at a mid-point, etc.). Also, as shown in FIG. 4, the connection location for the pull straps 34 (with respect to the vertical members 36) need not be identical for each pull strap 34 of a given mattress 28. As shown on the left-hand side of FIG. 4, for example, the depicted mattress 28 includes pull straps 34 attached adjacent top sheet 12 as well as pull straps 34 attached adjacent the bottom sheet 14.

In the same fashion as transfer mattress 10, the materials used for each of the fastener tabs 20, pull straps 34, vertical members 36 and cross members 26 of transfer mattress 28 is colored in the same shade. This is illustrated in FIG. 4 by the identical lining pattern applied to each of these elements. The color selected for application to the above-identified elements of transfer mattress 28 could be any color (e.g., yellow, blue, pink, gold, etc.). In a similar manner as that described above for mattress 10, the mattress 28 could be included in a set of mattresses, differing from each other based on size, and color-coded for matching an accessory (e.g., a liner) of a set of accessories.

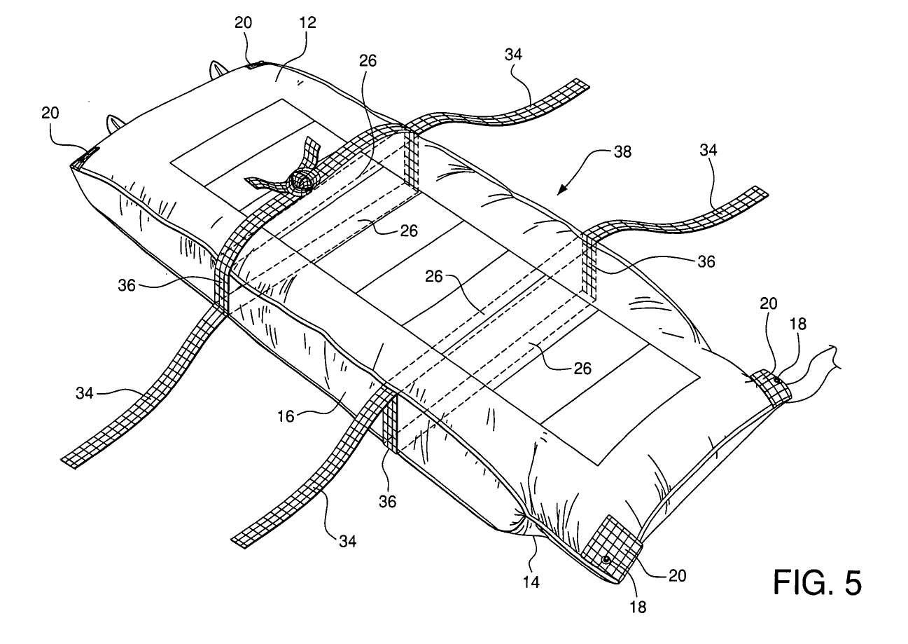

Referring to FIG. 5, there is shown a transfer mattress 38 according to a third exemplary embodiment of the invention. Similar to transfer mattress 28, the transfer mattress 38 includes top and bottom sheets 12, 14, side panels 16, and fasteners 18 mounted on tabs 20. Also similar to transfer mattress 28, the transfer mattress 38 includes elongated pull straps 34 attached to vertical members 36. The pull straps 34 include straps 34 attached to vertical members 36 adjacent the top sheet 12 and straps 34 attached to vertical members 36 adjacent the bottom sheet 14.

Similar to transfer mattress 28, the transfer mattress 38 includes cross members 26 extending between the opposite side panels 16 between the elongated straps 34. Unlike the transfer mattress 28, however, which included cross members only on the bottom of the mattress, the transfer mattress 38 includes cross members 26 secured to both the top sheet 12 and the bottom sheet 14. Also, as shown by broken line, the cross members 26 of mattress 38 are preferably located on the inner surfaces of the top and bottom sheets 12, 14 instead of the outer surface as shown in FIG. 5 for the cross members 26 of mattress 10.

As indicated by the identical lining pattern that is applied, the materials used for each of the fastener tabs 20, the pull straps 34 and the vertical members 36 of transfer mattress 28 is colored in the same shade. Cross members 26, however, are not illustrated with the line pattern for matching color with the above listed identifier elements of mattress 38 because, as described above, they are located within the interior of the mattress 38.

The use of color to visually identify selected elements of the transfer mattresses of a set of transfer mattresses has been described above as the means of visually distinguishing mattresses of a set of mattresses. The present invention, however, is not limited to colors. It is conceivable, for example, that certain visual patterns or designs could be applied to the selected elements of the mattresses to provide a visual basis on which to distinguish between mattresses.

The foregoing describes the invention in terms of embodiments preferred by the inventors for which an enabling description was available, notwithstanding that insubstantial modifications of the invention, including those not presently foreseen, may nonetheless represent equivalents thereto.

What is claimed is:

1. A system for visually identifying a patient transfer device and distinguishing the patient transfer device from other patient transfer devices in a set of transfer devices, the patient transfer device includes an inflatable mattress, the system comprising:
a plurality of identifier elements arranged about the mattress and adapted to present a unified appearance, the appearance of the identifier elements substantially distinct from that of the mattress such that the eye of a viewer is automatically drawn to the identifier elements.

2. The system according to claim 1, wherein the identifier elements are arranged about the mattress such that at least one of the identifier elements is presented to a viewer from any point of view.

3. The system according to claim 1, wherein the identifier elements include a plurality of elongated side pull straps each adapted for application of a pulling force to the mattress for sliding the mattress along an underlying support surface.

4. The system according to claim 1, wherein the patient transfer device includes a plurality of fasteners for releasably attaching an accessory to the mattress, and wherein the identifier elements include a plurality of mounting members secured to the mattress, each of the fasteners of the patient transfer device secured to one of the mounting members.

5. The system according to claim 1, wherein each of the identifier elements is made from a material having a color that is substantially identical to that of each other identifier elements.

6. The system according to claim 3, wherein the identifier elements further include loop members each having opposite ends secured to the mattress, each of the side pull straps secured at an end of the side pull strap to one of the loop members.

7. The system according to claim 3, wherein the identifier elements further include a plurality of cross members extending across a bottom sheet of the mattress.

8. A patient transfer device comprising:
an inflatable mattress defining a plurality of holes in a bottom sheet of the mattress for creating a cushion of escaping air beneath the transfer mattress to facilitate sliding movement of the mattress along an underlying surface;
a plurality of side pull straps each adapted for application of a pulling force to the mattress; and
a plurality of fasteners for releasably attaching an accessory to the mattress, each of the fasteners mounted on a tab,
the side pull straps and the tabs made from materials having a color, the color for each of the side pull straps and tabs being substantially identical such that the side pull straps and tabs function to visually identify the mattress and distinguish the mattress from other mattresses for matching the mattress with a corresponding accessory.

9. The patient transfer device according to claim 8 further comprising a plurality of loop straps each having opposite ends secured to the mattress, each of the side pull straps secured at an end of the side pull strap to one of the loop straps,
each of the loop straps made from a material having a color that is substantially identical to the color of the side pull straps and tabs.

10. The patient transfer device according to 9, wherein the mattress further includes a top sheet and opposite side panels located between the top and bottom sheets, each of the loop straps secured to one of the side panels of the mattress, the transfer device further comprising at least one reinforcing cross strap extending across the bottom sheet of the mattress between oppositely located pairs of the loop straps,
the at least one reinforcing cross strap made from a material having a color that is substantially identical to the color of the side pull straps and tabs.

11. The patient transfer device according to claim 8, wherein the side pull straps include a pair of side pull straps at each of a plurality of locations for the pull straps.

12. The patient transfer device according to claim 8, wherein the mattress further includes a top sheet and opposite side panels located between the top and bottom sheets, the transfer device further comprising side reinforcing members each secured to one of the side panels of the mattress, each of the side pull straps secured to one of the side reinforcing members,
each of the side reinforcing members made from a material having a color that is substantially identical to the color of the side pull straps and tabs.

13. The patient transfer device according to claim 11, wherein each pair of the side pull straps includes attachment means located adjacent terminal ends of the pull straps for releasably attaching the pair of straps to each other.

14. The patient transfer device according to claim 8, wherein the tabs are located about a periphery of the mattress adjacent a top sheet of the mattress for attaching an accessory across the top sheet of the mattress.

15. The patient transfer device according to claim 8 further comprising an accessory releasably attached to the mattress, the accessory including fasteners adapted for attachment to the fasteners of the mattress, each of the fasteners of the accessory located on a mounting member secured to the accessory,
each of the mounting members made from a material having a color that is substantially identical to the color of the side pull straps and tabs of the mattress.

16. The patient transfer device according to claim 15, wherein the mounting members of the liner include end strips each extending along an end edge of the liner and side tabs each located adjacent a periphery of the liner between the end strips.

17. A patient transfer device comprising:
an inflatable transfer mattress;
a plurality of side pull straps each adapted for application of a pulling force to the mattress; and
an accessory attached to the transfer mattress,
the side pull straps and at least a portion of the accessory made from materials having a color, the color for each of the side pull straps and the at least a portion of the accessory being substantially identical.
